(19) United States
(12) Patent Application Publication
(10) Pub. No.: US 2025/0243342 A1
(43) Pub. Date: Jul. 31, 2025

(54) Natural Cellulose and Protein-Based Materials

(71) Applicant: Null Objective, LLC, Essexville, MI (US)

(72) Inventor: Collin Clark, Bad Axe, MI (US)

(21) Appl. No.: 19/040,701

(22) Filed: Jan. 29, 2025

Related U.S. Application Data
(60) Provisional application No. 63/627,340, filed on Jan. 31, 2024.

(51) Int. Cl. C08K 5/00

(52) U.S. Cl. CPC C08K 5/0016; C08K 5/0025

(57) ABSTRACT

A method comprising providing an amount of phosphoprotein, mixing the phosphoprotein with an amount of pulverized cellulose-based material having a particulate size of from about 1 μm to about 1 mm, and adding water, a buffer solution, or both, to form a precursor composition.

### CLAIM OF PRIORITY

This application claims the benefit of the priority date of U.S. Provisional Application Ser. No. 63/627,340, filed on Jan. 31, 2024, the contents of that application being incorporated by reference herein in its entirety and for all purposes.

### FIELD OF THE INVENTION

The present teachings relates generally to natural materials for biodegradable plastic substitutes and methods for preparing those materials.

### BACKGROUND OF THE INVENTION

There is a well-established need for materials that provide some of the physical properties of plastics without the problems associated with traditional plastic waste. Efforts have been made to process natural materials that are more environmentally friendly to produce plastic substitutes. As one such example, in the late 19th and early 20th centuries casein was extracted from milk and extruded into a rod and then cut into buttons and sewing pins. The casein was cured using formaldehyde, which is a toxic and time-consuming process that caused casein to fall out of favor for use as a polymer. As another example, certain natural fibers can be used for structural support material.

US 2015/0013569 discloses a milk protein-based material that is plasticized by water or glycerol to form a moldable plastic.

US 2022/0185954 discloses bio-based combinations of natural elastomeric materials adapted to be molded to form recyclable materials.

US 2022/0275201 discloses materials and methods for making biodegradable plastic including polymers, fiber, starch, a plasticizer, and a coupling agent.

It would be desirable to have materials produced with natural, bio-based ingredients and minimal processing that mimic the mechanical characteristics of plastic but are easily recyclable and/or biodegradable.

### SUMMARY OF THE INVENTION

The teachings herein provide for a method comprising providing an amount of phosphoprotein, mixing the phosphoprotein with an amount of powdered cellulose-based material having a particulate size of from about 1 μm to about 1 mm, and adding water to form a precursor composition.

The teachings herein further provide for a method comprising providing an amount of phosphoprotein, mixing the phosphoprotein with an amount of powdered cellulose-based material having a particulate size of from about 1 μm to about 1 mm, and adding a buffer solution to form a precursor composition having a pH of from about 10.0 to about 11.

The precursor composition may be homogenized for at least 30 minutes. The precursor composition may be mixed with a plasticizer.

The precursor composition may be mixed with a plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The precursor composition may be mixed with a strengthening agent. The precursor composition may be mixed with a strengthening agent selected from the group consisting of graphite, calcium carbonate, other forms of carbon prepared by any means, glass, aluminum, powdered metals, or any combination thereof.

The precursor composition may be mixed with tannic acid prepared in a NaOH solution to form a secondary composition having a pH range of from about 10 to about 12.

The precursor composition may be mixed with a crosslinking agent to form a secondary composition having a pH range of from about 10 to about 12.

The secondary composition may be mixed with a plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The secondary composition may be subjected to an aeration process for a period of at least one hour.

The secondary composition may be treated with hydrochloric acid until a pH of from about 1.2 to about 4.7 is obtained to form a final composition.

The secondary composition may be treated with hydrochloric acid until a pH of from about 1.5 to about 2.3 is obtained to form a final composition.

The final composition may be mixed with a plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The method may include air drying the final composition to a moisture content of less than 15%.

The method may include injection molding, blow molding, compression molding, film forming, or extruding the final composition after air drying.

The buffer solution may be selected from a carbonate, ammonium, ammonium hydroxide, aniline, methylamine, ethylamine, aluminum hydroxide, magnesium hydroxide, pyridine, or any combination thereof.

The method may include adding a fire retardant material to the precursor composition.

The ratio of phosphoprotein to cellulose-based material may be about 2:1. The ratio of phosphoprotein to cellulose-based material may be about 1:1.

The method may include adding a crosslinker to the precursor composition wherein the ratio of phosphoprotein to crosslinker is from about 40:1 to about 5:1.

The method may include adding a plasticizer to the precursor composition, secondary composition, or final composition wherein the ratio of phosphoprotein to plasticizer is from about 10:1 to about 2:1.

The method may include a step of injection molding at a temperature of from about 125° C. to about 250° C.

The plant-based material may be selected from hemp hurd, tree hurd, woody plant hurd, corn starch, corn stover, jute, flax, cotton, or any combination thereof.

The teachings herein are further directed to a method comprising providing an amount of phosphoprotein, mixing the phosphoprotein with an amount of powdered cellulose-based material having a particulate size of from about 1 μm to about 1 mm, adding water to form a precursor composition, homogenizing the precursor composition for at least 30 minutes, mixing the precursor composition with tannic acid prepared in a NaOH solution to form a secondary composition, and treating the secondary composition with hydrochloric acid until a pH of from about 1.2 to about 4.7 is obtained to form a final composition.

The teachings herein are further directed to a method comprising providing an amount of phosphoprotein, mixing the phosphoprotein with an amount of powdered cellulose-based material having a particulate size of from about 1 μm to about 1 mm, adding a buffer solution to form a precursor composition having a pH of from about 10.3 to about 11, homogenizing the precursor composition for at least 30 minutes, mixing the precursor composition with tannic acid prepared in a NaOH solution to form a secondary composition, and treating the secondary composition with hydrochloric acid until a pH of from about 1.2 to about 4.7 is obtained to form a final composition.

The precursor composition, secondary composition, or final composition may be mixed with a plasticizer. The precursor composition may be mixed with a plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The precursor composition may be mixed with a strengthening agent.

The strengthening agent may be selected from the group consisting of graphite, calcium carbonate, other forms of carbon prepared by any means, glass, aluminum, powdered metals, or any combination thereof.

The buffer solution may be selected from a carbonate, ammonium, ammonium hydroxide, aniline, methylamine, ethylamine, aluminum hydroxide, magnesium hydroxide, pyridine, or any combination thereof.

The plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The secondary composition may be treated with hydrochloric acid until a pH of from about 1.5 to about 2.3 is obtained.

The teachings herein are also directed to a heat-processable material comprising an amount of phosphoprotein, an amount of cellulose-based material, water, a cross-linking agent; and a strong acid. The ratio of the amount of phosphoprotein to the amount of cellulose-based material is about 2:1 or about 1.1.

The teachings herein are also directed to a heat-processable material comprising an amount of phosphoprotein, an amount of cellulose-based material, a buffer solution, a cross-linking agent; and a strong acid. The ratio of the amount of phosphoprotein to the amount of cellulose-based material is about 2:1 or about 1.1.

The cross-linking agent may be selected from tannic acid, formic acid (HCOOH), acetic acid (CH₃COOH), benzoic acid (C₆H₅COOH), oxalic acid (C₂H₂O₄), hydrofluoric acid (HF), nitrous acid (HNO₂), sulfurous acid (H₂SO₃), phosphoric acid (H₃PO₄), or combinations thereof. The crosslinking agent may be tannic acid.

The cellulose-based material may be selected from hemp hurd, tree hurd, woody plant hurd, corn starch, corn stover, jute, flax, cotton, or combinations thereof. The cellulose-based material may be hemp.

The material may include a plasticizer. The plasticizer may be selected from ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

The material may include a strengthening agent. The strengthening agent may be selected from graphite, calcium carbonate, other forms of carbon prepared by any means, glass, aluminum, powdered metals, or any combination thereof.

The strong acid may be hydrochloric acid.

The material may have a pH of from about 1.2 to about 4.7. The material may have a pH of from about 1.5 to about 2.3.

The buffer solution may be selected from a carbonate, ammonium, ammonium hydroxide, aniline, methylamine, ethylamine, aluminum hydroxide, magnesium hydroxide, pyridine, or any combination thereof.

The material may be biodegradable.

The teachings herein are further directed to use of the material of any of the preceding claims for forming a composite structure.

The teachings herein are further directed to use of the material of any of the preceding claims to replace a plastic material.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present invention is predicated upon the provision of an improved bio-based material and articles incorporating the same. The bio-based material may be treated to form a material adapted to be heat treated and/or cured and formed into a rigid structure.

The starting materials utilized for the methods described herein may be natural bio-based materials (e.g., cellulose-based materials). The natural material may be from an animal, vegetable, or mineral source. The natural material may be selected from cotton, wool, linen, silk, jute, bamboo, hemp hurd, tree hurd, woody plant hurd, corn starch, corn stover, jute, flax, or any combination thereof. The natural material may be selected from any grain or vegetable. The natural material may be selected as a strengthening component to provide rigidity and strength to the final formed product. It is also possible that recycled materials may be utilized. It is also possible that materials may be selected that are not considered natural (e.g., synthetic materials). Such synthetic materials may be used on their own or in combination with natural materials.

The starting materials may include a fibrous component, a powdered component, or a particulated component. The fibrous component, powdered component, or particulated component may be natural. The fibrous component, powdered component, or particulated component may be synthetic. The fibrous component, powdered component, or particulated component may be a combination of natural and synthetic.

If a fibrous material is utilized, the processing of the fibers may require additional processing steps to avoid undesired amalgamation of the fibers. It may be necessary to reduce the size of the fibers to reduce the amalgamation. The higher tensile strength fibers may present additional challenges in cutting down to size and so standard blending or other mechanical techniques may be insufficient. The length of the fibers may be reduced to a length that is less than 10 mm, less than 5 mm, less than 2 mm, or even less than 0.5 mm. The length of the fibers may differ depending on the types of fiber used.

If a powdered material is utilized, the size of the particles may be less than 1 mm, less than 1 μm, or even less than 1 nm. The particle size may refer to the particle diameter in which the particle diameter is taken as the largest diameter of the particle. The particles may be spherical, rounded, cylindrical, spongey, acicular, needle-shaped, plate-like, irregular, cuboidal, or aggregated.

If a particulated material is utilized, the size of the particulates may be anywhere from about 1 μm to about 1 mm. Preferably, the size of the particulates is greater than 5 μm. Preferably, the size of the particulates is less than 50 μm. It is also possible that the particulated material is a flour or corn starch.

In the event that a hemp fiber is used, the fibrous encasing of the hemp stalk may be removed and discarded and the wood core of the hemp stalk may be pulverizing into a particulated format which may be a powder. In this scenario, the advantages of the hemp from a material strength perspective can be utilized without encountering some of the challenges of using hemp fibers.

In the event that corn stover is used, the largest dimension of the particulates may be less than 800 nm, less than 700 nm, less than 600 nm, or even less than 500 nm. The largest dimension of the corn stover particulates may be greater than 100 nm, greater than 200 nm, greater than 300 nm, or even greater than 400 nm.

The starting materials may include one or more phosphoprotein components. The phosphoproteins may be collected from a casein material. The one or more phosphoproteins may be in the form of a micellar casein powder. The one or more phosphoprotein components may be selected from alpha-S1-casein, alpha-S2-casein, beta-casein, kappa-casein, or combinations thereof. Other phosphoproteins may also be selected, including 4E-BP1, Akt, Caspase-3, CHOP, EGFR, ERK-½, FRS2, GAPDH, GSK-3B, HIF-1a, Histone H3, IGF-1R, IR, IRS-1, JNK, MEK ½, MEK2, Met, p38, p53, p70S6K, PARP, PRAS40, PSD-95, PTEN, S6RP, STAT3, STAT4, STAT5a/b, Tau, Trk-A, Wnt3a, or combinations thereof.

Upon combining the starting materials (e.g., the phosphoproteins and cellulose-based material (e.g., fibrous, powdered, or particulate natural materials), the ratio of phosphoprotein to cellulose-based material may be about 2:1. The ratio of phosphoprotein to cellulose-based material may be about 1:1.

The fibrous, powdered, or particulated materials (or a combination thereof) may be combined with one or more phosphoproteins to form a precursor composition. Upon contact, the precursor composition may be treated with a crosslinking agent. The crosslinking agent may be selected from tannic acid, formic acid (HCOOH), acetic acid (CH₃COOH), benzoic acid (C₆H₅COOH), oxalic acid (C₂H₂O₄), hydrofluoric acid (HF), nitrous acid (HNO₂), sulfurous acid (H₂SO₃), phosphoric acid (H₃PO₄), or combinations thereof. The crosslinking agent may be mixed with the phosphoproteins (e.g., in the form of casein) under basic conditions so that it forms hydrogen bonds that link the casein protein molecules. As a result, increased molecular cohesion occurs leading to a higher strength material. Additionally, a crosslinking agent with hydrophobic properties may be selected so that it allows for the final material to have a degree of water resistance. This is important because exposure to water triggers the degradation of the resulting material. Thus, a material with a higher concentration of crosslinker will have significantly more resistance to degradation than that with a lower concentration of crosslinker. The crosslinking agent may be added in combination with a basic solution such as NaOH. The resulting ratio of phosphoprotein to crosslinker may be from about 40:1 to about 5:1.

The phosphoproteins may be utilized in the form of casein which may be in the form of instantized and unflavored casein protein powder or micellar casein powder. It is also possible that raw casein can be extracted from milk. Enzymes and/or acids can be utilized in this extraction process. One not limiting example of an acid for extraction is HCl (hydrochloric acid). If the casein is derived from milk, it may be preferred that skim milk is selected to avoid contamination of the precursor composition by milk fat. Advantages may be recognized with the use of finer, raw particles as the smaller particle sizes discussed herein improves the smoothness and cohesion of the molded product.

A plasticizer may be used to improve the overall flexibility of the resulting material, as a material without a plasticizer tends to retain a significant brittle character. The plasticizer may be selected from ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof. In one embodiment, glycerol is used for the plasticizer. The ratio of phosphoprotein to plasticizer may be from about 10:1 to about 2:1. It is preferable that the plasticizer is added to the secondary or final composition.

The precursor composition may be combined with a strengthening agent. The strengthening agent may be selected from the group consisting of graphite, calcium carbonate, other forms of carbon prepared by any means, glass, aluminum, powdered metals, or any combination thereof.

Throughout the process, various components may be utilized to alter the pH of the materials. The initial conditions of the process should be basic and stability of the pH throughout the process is advantageous. The pH may be altered by use of sodium hydroxide solution (1.0M) and diligent pH monitoring. Alternatively, a buffer solution may be utilized. The buffer may be prepared to a pH of 10.5 and a concentration of 0.1M but may have a higher molarity (0.3-5.0M or even higher). Upon the initial mixing of the phosphoproteins and natural fiber, powdered, or particulate material, a buffer solution may be added so that the resulting precursor composition has a pH of from about 10 to about 11. Upon or prior to mixing the precursor composition with the plasticizer and/or strengthening agent, the crosslinking agent (potentially including a basic solution) may be added in an effort to maintain the resulting composition at a pH from about 10 to about 12.

The buffer solution may be selected from a carbonate, ammonium, ammonium hydroxide, aniline, methylamine, ethylamine, aluminum hydroxide, magnesium hydroxide, pyridine, or any combination thereof. The buffer solution may be added in an amount sufficient to maintain the precursor composition at a pH of from about 10 to about 11.

During processing, it may be beneficial to limit the amount of water in any precursor or final composition. If the amount of water is limited throughout the duration of the process, a pronounced foaming action may not occur. It is also desirable that the viscosity of the composition prior to any heating and/or molding step will be at least 3000 CPS, at least 4000 CPS, or even at least 5000 CPS measured at room temperature.

Once the phosphoproteins, natural fiber/particulate, buffer solution crosslinking agent, and optional plasticizers and strengthening agents have been mixed, the resulting secondary composition may be exposed to an aeration process for at least 30 minutes, at least 60 minutes, at least 90 minutes, or even at least 120 minutes. After the aeration process, the secondary composition may be treated with a strong acid such as hydrochloric acid so that the pH of the final composition is reduced to about 1.2 to about 4.7, and preferably reduced to about 1.5 to about 2.3.

Once the final composition is formed during acid treatment, the final composition may be dried (e.g., air-dried) to a moisture content of less than 15%. A reduction in moisture within the material is thought to aid in downstream processing steps. Such downstream processing steps may include injection molding, blow molding, compression molding, film forming, or extruding the final composition. Downstream processing may involve a step of heating the composition. For example, downstream processing may comprise an injection molding process at a temperature of from about 125° C. to about 250° C.

Additional additives such as fire retardants (e.g., halogen-free fire retardants), colorants, lubricants, fillers, diluents, may be added to improve processability or function. Specifically, additional graphite or powdered aluminum can be added after chemical processing for flame retardancy and to increase thermal conductivity. Powdered dyes, liquid dyes, or both may be added prior to or during the molding process to modify the color of the composition.

Extensive co-molding, coating applications or a combination thereof can be used on the final composition to apply wax in order to improve water resistance. Rubber overmolding, silicone overmolding, or a combination thereof may be applied to the final composition to improve shock absorbance. Paint, lacquer, or a combination thereof may be applied to the final composition to alter the visible appearance, improve functionality, or a combination thereof. Plastic films, thin-walled plastic casings may be formed around the final composition. Epoxy coatings may be applied to the final composition. Lubricants may be used with the final composition to improve flow during extrusion or injection molding processes.

It is to be understood that what has been described are the preferred embodiments of the invention. The scope of the claims should not be limited by the preferred embodiments set forth above but should be given the broadest interpretation consistent with the description as a whole.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in terms of “‘x’ parts by weight of the resulting polymeric blend composition” also contemplates a teaching of ranges of same recited amount of “x” in percent by weight of the resulting polymeric blend composition.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components, or steps identified, and such other elements ingredients, components, or steps that do not materially affect the basic and novel characteristics of the combination. The use of the terms “comprising” or “including” to describe combinations of elements, ingredients, components, or steps herein also contemplates embodiments that consist of, or consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method comprising:
providing an amount of phosphoprotein;
mixing the phosphoprotein with an amount of pulverized cellulose-based material having a particulate size of from about 1 μm to about 1 mm;
adding water, a buffer solution, or both to form a precursor composition.

2. The method of claim 1, wherein the precursor composition is homogenized for at least 30 minutes.

3. The method of claim 1, wherein the precursor composition is mixed with a strengthening agent.

4. The method of claim 1, wherein the precursor composition is mixed with tannic acid prepared in a NaOH solution to form a secondary composition having a pH range of from about 10 to about 12.

5. The method of claim 1, wherein the precursor composition is mixed with a crosslinking agent to form a secondary composition having a pH range of from about 10 to about 12.

6. The method of claim 4, wherein the secondary composition is subjected to an aeration process for a period of at least one hour.

7. The method of claim 4, wherein the secondary composition is treated with hydrochloric acid until a pH of from about 1.2 to about 4.7, or even from about 1.5 to 2.3 is obtained to form a final composition.

8. The method of claim 4, wherein the secondary composition is mixed with a plasticizer.

9. The method of claim 7, including air drying the final composition to a moisture content of less than 15%.

10. The method of claim 7, including injection molding, blow molding, compression molding, film forming, or extruding the final composition after air drying.

11. The method of claim 1, wherein a fire retardant material is added to the precursor composition.

12. The method of claim 1, wherein the ratio of phosphoprotein to cellulose-based material is about 2:1, or even about 1:1.

13. The method of claim 7, including molding the final composition to form a molded product.

14. The method of claim 1, including adding a crosslinker to the precursor composition wherein the ratio of phosphoprotein to crosslinker is from about 40:1 to about 5:1.

15. The method of any claim 1, wherein the plant-based material is selected from hemp hurd, tree hurd, woody plant hurd, corn starch, corn stover, jute, flax, cotton, or any combination thereof.

16. A heat-processable material comprising:
an amount of phosphoprotein;
an amount of cellulose-based material;
an amount of water;
a cross-linking agent; and
a strong acid
wherein the ratio of the amount of phosphoprotein to the amount of cellulose-based material is about 2:1 or about 1.1.

17. The material of claim 16, wherein the cellulose-based material is selected from hemp hurd, tree hurd, woody plant hurd, corn starch, corn stover, jute, flax, cotton, or combinations.

18. The material of claim 16, wherein the cross-linking agent is selected from tannic acid, formic acid (HCOOH), acetic acid (CH₃COOH), benzoic acid (C₆H₅COOH), oxalic acid (C₂H₂O₄), hydrofluoric acid (HF), nitrous acid (HNO₂), sulfurous acid (H₂SO₃), phosphoric acid (H₃PO₄), or combinations thereof.

19. The material claim 16, including a plasticizer selected from the group consisting of ester plasticizers (fatty acid esters, hydroxycarboxylic acid esters, isophthalate esters, phosphate esters, phthalate esters, polyalcohol esters, tetrahydrophthalate esters, trimellitate esters), polyalcohol ethers, glycols, formamide, urea, citric or melic acid, polyols, or any combination thereof.

20. The material of claim 16, including a strengthening agent selected from the group consisting of graphite, calcium carbonate, other forms of carbon prepared by any means, glass, aluminum, powdered metals, or any combination thereof.
